(19) United States
(12) Patent Application Publication
(10) Pub. No.: US 2015/0109528 A1
(43) Pub. Date: Apr. 23, 2015

(54) APPARATUS AND METHOD FOR PROVIDING MOTION HAPTIC EFFECT USING VIDEO ANALYSIS

(71) Applicant: POSTECH ACADEMY-INDUSTRY FOUNDATION, Pohang-si (KR)

(72) Inventors: Seung Moon CHOI, Pohang-si (KR); Jae Bong LEE, Pohang-si (KR)

(21) Appl. No.: 14/518,238

(22) Filed: Oct. 20, 2014

(30) Foreign Application Priority Data
Oct. 21, 2013 (KR) 10-2013-0125156

(51) Int. Cl. H04N 5/14; H04N 21/81; H04N 21/44; G06T 7/20; G08B 6/00; H04N 21/845

(52) U.S. Cl. CPC H04N 5/145; G08B 6/00; H04N 21/845; H04N 21/44008; G06T 7/2093; H04N 21/816; G06T 2207/10016
USPC 348/460

(57) ABSTRACT

Provided are an apparatus and method for providing a motion haptic effect using video analysis. The apparatus includes a camera viewpoint classifier configured to analyze the camera viewpoint of an input video and classify the input video as a first-person viewpoint video or a third-person viewpoint video, a first-person viewpoint video processor configured to estimate a camera egomotion for the first-person viewpoint video, and a third-person viewpoint video processor configured to estimate a global motion of a target object for tracking included in the third-person viewpoint video. Accordingly, it is possible to effectively generate multimedia content capable of providing a motion haptic effect.

### CLAIM FOR PRIORITY

This application claims priority to Korean Patent Application No. 10-2013-0125156 filed on Oct. 21, 2013 in the Korean Intellectual Property Office (KIPO), the entire contents of which are hereby incorporated by reference.

### BACKGROUND

1. Technical Field

Example embodiments of the present invention relate in general to the provision of a motion haptic effect, and more particularly, to an apparatus and method for providing a motion haptic effect using video analysis.

2. Related Art

Currently, haptics is being applied to various types of multimedia content, such as games, movies, and music. For example, haptics is being applied to various vibrating earphones and headphones, home theater systems, four-dimensional (4D) movie theaters, sensory gaming machines, smartphones, and tablet personal computers (PCs).

Particularly, in the movie industry, many five-sense experience theaters have opened. Although these five-sense experience theaters provide various sensory impulses, such as vibrations, water, wind, and scents, the most fundamental and important effect among the sensory impulses is a motion haptic effect that is experienced as a realistic motion when a chair is moved up, down, left, and right.

Currently, to provide a motion haptic effect, an expert directly designs an effect suitable for content. In other words, much time and cost is involved in providing a motion haptic effect suitable for content, making it difficult to provide various pieces of content to which high-quality motion haptic effects are applied.

In addition, technologies for automatically providing a haptic effect suitable for multimedia content like an existing technology for automatically generating a haptic event from a digital audio signal are under development.

However, all these technologies are limited to the provision of a vibrating haptic effect, and it is difficult to effectively provide a motion haptic effect suitable for content.

### SUMMARY

Accordingly, example embodiments of the present invention are proposed to substantially obviate one or more problems of the related art as described above, and provide an apparatus and method for effectively generating multimedia content capable of providing a motion haptic effect.

Other purposes and advantages of the present invention can be understood through the following description, and will become more apparent from example embodiments of the present invention. Also, it is to be understood that purposes and advantages of the present invention can be easily achieved by means disclosed in claims and combinations thereof.

In some example embodiments, an apparatus for providing a motion haptic effect using video analysis includes: a camera viewpoint classifier configured to analyze a camera viewpoint of an input video and classify the input video as a first-person viewpoint video or a third-person viewpoint video; a first-person viewpoint video processor configured to estimate a camera egomotion for the first-person viewpoint video; and a third-person viewpoint video processor configured to estimate a global motion of a target object for tracking included in the third-person viewpoint video.

Here, the apparatus for providing a motion haptic effect may further include a velocity information converter configured to convert the camera egomotion for the first-person viewpoint video or the global motion of the target object into acceleration information.

Here, the apparatus for providing a motion haptic effect may further include a motion haptic feedback unit configured to generate motion haptic feedback based on the acceleration information from a viewpoint of a viewer who views the input video.

Here, the first-person viewpoint video processor may calculate an optical flow of the first-person viewpoint video, and estimate the camera egomotion for the first-person viewpoint video based on the optical flow.

Here, the third-person viewpoint video processor may separate the target object from a background area.

Here, the third-person viewpoint video processor may calculate motion of the target object, and estimate a camera egomotion for the third-person viewpoint video based on the background area.

Here, the third-person viewpoint video processor may estimate the global motion of the target object in a global coordinate system by considering the camera egomotion for the third-person viewpoint video for the motion of the target object.

Here, the input video may be a two-dimensional (2D) or three-dimensional (3D) video.

In other example embodiments, a method of providing a motion haptic effect using video analysis includes: estimating a camera egomotion for a first-person viewpoint video; converting the camera egomotion for the first-person viewpoint video into acceleration information; and generating motion haptic feedback based on the acceleration information from a viewpoint of a viewer who views the first-person viewpoint video.

In other example embodiments, a method of providing a motion haptic effect using video analysis includes: estimating a global motion of a target object for tracking included in a third-person viewpoint video; converting the global motion of the target object into acceleration information; and generating motion haptic feedback based on the acceleration information from a viewpoint of a viewer who views the third-person viewpoint video.

In other example embodiments, a method of providing a motion haptic effect using video analysis includes: analyzing a camera viewpoint of an input video and classifying the input video as a first-person viewpoint video or a third-person viewpoint video; estimating a camera egomotion for the first-person viewpoint video when the input video is classified as the first-person viewpoint video; and estimating a global motion of a target object for tracking included in the third-person viewpoint video when the input video is classified as the third-person viewpoint video.

### BRIEF DESCRIPTION OF DRAWINGS

Example embodiments of the present invention will become more apparent by describing in detail example embodiments of the present invention with reference to the accompanying drawings, in which:

FIG. 1 is a block diagram showing the constitution of an apparatus for providing a motion haptic effect using video analysis according to an example embodiment of the present invention;

FIG. 2 is a conceptual diagram illustrating the provision of a motion haptic effect using video analysis according to an example embodiment of the present invention; and

FIG. 3 is a flowchart illustrating a method of providing a motion haptic effect using video analysis according to an example embodiment of the present invention.

### DESCRIPTION OF EXAMPLE EMBODIMENTS OF THE PRESENT INVENTION

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

Terms used herein will be described below first.

Haptics denotes technology enabling a user to feel vibrations, motion, force, etc. while manipulating various input devices of a gaming machine or a computer, such as a joystick, a mouse, a keyboard, or a touchscreen, and thereby delivering realistic information to the user, as in computer virtual reality.

A motion haptic effect may denote information or an impulse that enables a user to feel motion in up, down, left, right, and other directions.

A first-person viewpoint may denote a viewpoint from a main character of an input video or a camera that has captured the input video, and a third-person viewpoint may denote a viewpoint from a particular object included in an input video.

Therefore, a first-person viewpoint video may denote a video based on a first-person viewpoint, and a third-person viewpoint video may denote a video based on a third-person viewpoint.

Egomotion denotes motion of an observer's body or head, and in example embodiments of the present invention, may denote motion of a camera that captures an input video.

Optical flow is an image processing technique for modeling the vision of a human or an animal, and may denote a process of comparing the preceding and following frames in a video to extract the motion pattern of an object, a surface, an edge, etc., and obtaining information on the degree and the direction of motion of the target object.

Hereinafter, example embodiments of the present invention will be described in detail with reference to the accompanying drawings.

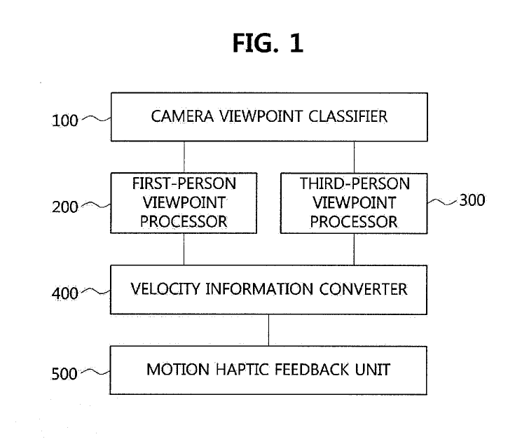

FIG. 1 is a block diagram showing the constitution of an apparatus for providing a motion haptic effect using video analysis according to an example embodiment of the present invention.

Referring to FIG. 1, an apparatus for providing a motion haptic effect using video analysis (referred to as “apparatus for providing a motion haptic effect”) according to an example embodiment of the present invention includes a camera viewpoint classifier 100, a first-person viewpoint video processor 200, a third-person viewpoint video processor 300, a velocity information converter 400, and a motion haptic feedback unit 500.

The camera viewpoint classifier 100 may analyze the camera viewpoint of an input video and classify the input video as a first-person viewpoint video or a third-person viewpoint video. Here, the input video may be a two-dimensional (2D) or three-dimensional (3D) video.

Specifically, the camera viewpoint classifier 100 can automatically classify the viewpoint by applying an object recognition or action recognition algorithm to the input video.

For example, when a plurality of cars are recognized and a current scene is recognized as a car chase scene, the video is highly likely to be a third-person viewpoint video. On the other hand, when the steering wheel, the interior, etc. of a car are recognized in the lower portion or the boundary and a road is recognized at the center, the video is highly likely to be a first-person viewpoint video. As occasion demands, a person may determine a viewpoint mode.

The first-person viewpoint video processor 200 may estimate a camera egomotion for a first-person viewpoint video. In other words, in the case of a first-person viewpoint video, only motion based on the camera viewpoint from which the input video has been captured may be analyzed and used.

Specifically, the first-person viewpoint video processor 200 may calculate the optical flow of the first-person viewpoint video, and estimate a camera egomotion for the first-person viewpoint video based on the optical flow.

However, the estimation of a camera egomotion for a first-person viewpoint video according to example embodiments of the present invention is not limited to estimation based on an optical flow, and a method of matching feature points between two consecutive frames may be used. For example, a scale-invariant feature transform (SIFT) algorithm may be used.

The third-person viewpoint video processor 300 may estimate a global motion of a target object for tracking included in a third-person viewpoint video.

Specifically, the third-person viewpoint video processor 300 may recognize the target object for tracking first. For example, the target object for tracking may be directly selected by a user, or automatically found by selecting an object at the point of the highest degree of saliency in a visual saliency map.

Then, the third-person viewpoint video processor 300 may separate the target object from a background area, and calculate motion of the target object. For example, by applying a 3D pose tracking method to the area of the target object for tracking, a 3D motion of the target object may be calculated.

Also, the third-person viewpoint video processor 300 may estimate a camera egomotion for the third-person viewpoint video based on the background area. Therefore, the third-person viewpoint video processor 300 may estimate a global motion of the target object in the global coordinate system by considering the camera egomotion for the third-person viewpoint video for the motion of the target object. In other words, since the motion of the target object is based on the camera viewpoint, it is not possible to accurately obtain actual motion unless motion of a camera is taken into consideration and subtracted from the motion of the target object. Therefore, the camera egomotion for the third-person viewpoint video may be derived from the background area and used.

The velocity information converter 400 may convert the camera egomotion for the first-person viewpoint video or the global motion of the target object into acceleration information. For example, the velocity information converter 400 may change the camera egomotion for the first-person viewpoint video or the global motion of the target object, which is 3D position information, to 3D velocity information first, and then convert the 3D velocity information into 3D acceleration information.

The motion haptic feedback unit 500 may generate motion haptic feedback based on the acceleration information from the viewpoint of a viewer who views the input video. In other words, a motion platform may be moved up, down, left, and right so that the viewer can realistically feel acceleration calculated from the first-person viewpoint. For example, the motion haptic feedback unit 500 may be a physical mechanism for providing a motion effect to the user, or may operate in conjunction with the physical mechanism. Here, the physical mechanism may have the form of a chair on which the user may sit, but is not limited to the form of a chair.

In example embodiments of the present invention, techniques such as optical flow, scene flow, ego-motion estimation, object tracking, and pose tracking may be used for the recognition and the motion estimation of a target object.

For convenience, the respective components of the apparatus for providing a motion haptic effect according to an example embodiment of the present invention have been separately described. However, at least two of the components may be combined into one component, or one component may be divided into a plurality of components and perform functions. These cases of an embodiment in which respective components are combined and an embodiment in which a component is divided are also included in the scope of the present invention as long as they do not depart from the spirit of the present invention.

The apparatus for providing a motion haptic effect according to an example embodiment of the present invention can be implemented as a computer-readable program or code in computer-readable recording media. The computer-readable recording media include all types of recording media storing data that can be read by a computer system. In addition, the computer-readable recording media are distributed to computer systems connected over a network, so that the computer-readable program or code can be stored and executed in a distributed manner.

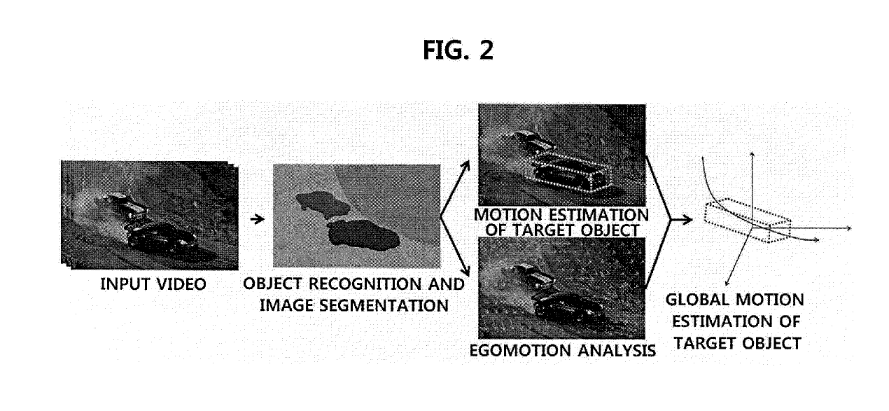

FIG. 2 is a conceptual diagram illustrating the provision of a motion haptic effect using video analysis according to an example embodiment of the present invention.

With reference to FIG. 2, a method of providing a motion haptic effect when an input video is a third-person viewpoint video will be described.

A 2D or 3D input video may be received, and when the input video is classified as a third-person viewpoint video, a target object for tracking may be recognized in the third-person viewpoint video. The target object for tracking may be directly selected by a user, or automatically found by selecting an object at the point of the highest degree of saliency in a visual saliency map.

From the third-person viewpoint video, the target object and a background area may be separated (image segmentation).

Next, motion of the target object may be estimated by the pose tracking of the target object. Also, a camera egomotion for the third-person viewpoint video may be estimated by ego-motion estimation based on the background area.

Since the motion of the target object is based on a camera viewpoint, it is necessary to take motion of a camera into consideration. Therefore, by considering the camera egomotion for the third-person viewpoint video for the motion of the target object, it is possible to estimate a global motion of the target object in a global coordinate system.

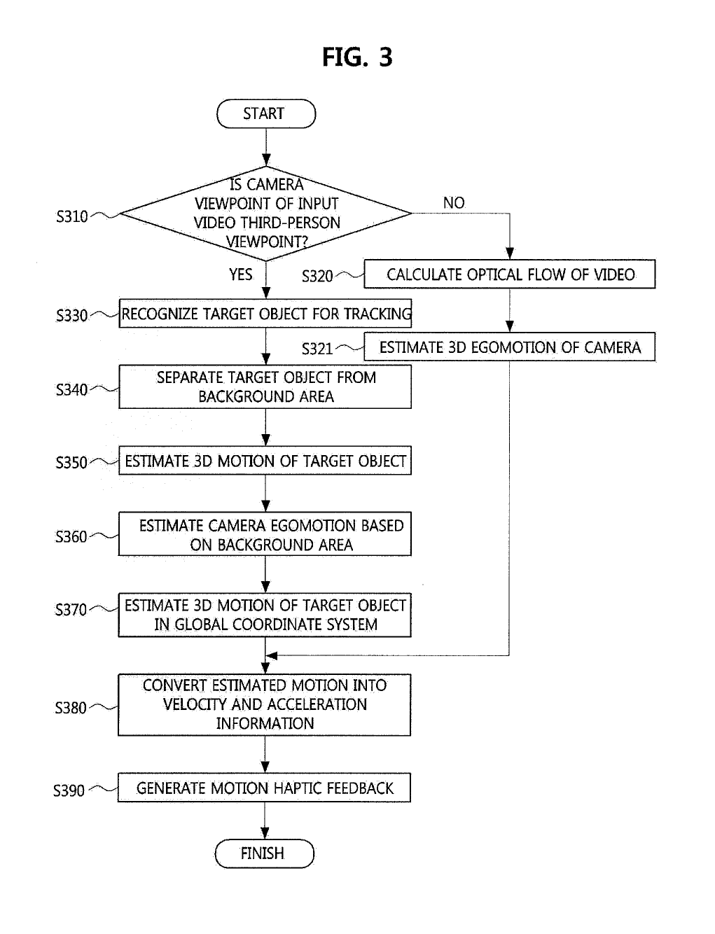

FIG. 3 is a flowchart illustrating a method of providing a motion haptic effect using video analysis according to an example embodiment of the present invention.

A method of providing a motion haptic effect (referred to as “method of providing a motion haptic effect”) according to an example embodiment of the present invention includes an operation of analyzing a camera viewpoint of an input video and classifying the input video as a first-person viewpoint video or a third-person viewpoint video, an operation of estimating a camera egomotion for the first-person viewpoint video when the input video is classified as the first-person viewpoint video, and an operation of estimating a global motion of a target object for tracking included in the third-person viewpoint video when the input video is classified as the third-person viewpoint video.

In addition, the method may further include an operation of converting a camera egomotion for the first-person viewpoint video or the global motion of the target object into acceleration information, and an operation of generating motion haptic feedback based on the acceleration information from a viewpoint of a viewer who views the input video.

Referring to FIG. 3, it is possible to classify whether the camera viewpoint of a received input video is a first-person viewpoint or a third-person viewpoint (S310).

First, when the camera viewpoint of the input video is a first-person viewpoint, the optical flow of the first-person viewpoint video may be calculated (S320), and a camera egomotion for the first-person viewpoint video may be estimated based on the optical flow (S321). The 3D egomotion of a camera that has captured the input image may be estimated. In other words, in the case of a first-person viewpoint video, only motion based on the camera viewpoint from which the input video has been captured may be analyzed and used.

Therefore, motion estimated based on the egomotion of the camera is converted into speed and acceleration information (S380), and motion haptic feedback may be generated using the converted acceleration information and provided to a user (S390).

On the other hand, when the camera viewpoint of the input video is a third-person viewpoint, the method may include an operation of separating a target object from a background area, an operation of calculating motion of the target object, an operation of estimating a camera egomotion for the third-person viewpoint video based on the background area, and an operation of estimating a global motion of the target object in a global coordinate system by considering the camera egomotion for the third-person viewpoint video for the motion of the target object.

Specifically, a target object for tracking may be recognized in the third-person viewpoint video (S330). For example, the target object for tracking may be directly selected by the user, or automatically found by selecting an object at the point of the highest degree of saliency in a visual saliency map.

The target object may be separated from a background area (S340), and 3D motion of the target object may be estimated (S350). At this time, optical flow, object tracking, and pose tracking techniques may be used for motion estimation.

Also, a camera egomotion for the third-person viewpoint video may be estimated based on the background area (S360). To this end, an ego-motion estimation technique may be used.

By considering the camera egomotion for the third-person viewpoint video for the motion of the target object, a global motion of the target object in a global coordinate system may be estimated (S370).

The global motion of the target object is converted into speed and acceleration information (S380), and motion haptic feedback may be generated using the converted acceleration information and provided to a user (S390).

The apparatus and method for providing a motion haptic effect according to example embodiments of the present invention can be implemented in real time in a computer, a television (TV), or movie theater equipment. Also, the apparatus and method can be used in gaming machines or home theater systems.

For example, while a user views a movie at home, a car chase scene may be shown. At this time, if the user presses an “Automatic Haptic” button, a chair on which the user is sitting moves to physically recreate motion of a car, so that the user can realistically enjoy the movie.

Meanwhile, the apparatus and method for providing a motion haptic effect according to example embodiments of the present invention can be included as components in a tool dedicated to creating multimedia content. For example, the creator of content capable of providing a motion haptic effect may generate a rough motion haptic effect using an automatic generation function, and then complete a final result by correcting the generated effect in detail.

The above-described apparatus and method for providing a motion haptic effect according to example embodiments of the present invention can be implemented in real time in a computer, a TV, or movie theater equipment, and can also be used in gaming machines or home theater systems.

In addition, an apparatus for providing a motion haptic effect according to example embodiments of the present invention is included as a component in a tool dedicated to creating multimedia content, so that content capable of providing a motion haptic effect can be effectively created.

While the example embodiments of the present invention and their advantages have been described in detail, it should be understood that various changes, substitutions and alterations may be made herein without departing from the scope of the invention.

What is claimed is:

1. An apparatus for providing a motion haptic effect using video analysis, the apparatus comprising:
a camera viewpoint classifier configured to analyze a camera viewpoint of an input video and classify the input video as a first-person viewpoint video or a third-person viewpoint video;
a first-person viewpoint video processor configured to estimate a camera egomotion for the first-person viewpoint video; and
a third-person viewpoint video processor configured to estimate a global motion of a target object for tracking included in the third-person viewpoint video.

2. The apparatus of claim 1, further comprising a velocity information converter configured to convert the camera egomotion for the first-person viewpoint video or the global motion of the target object into acceleration information.

3. The apparatus of claim 2, further comprising a motion haptic feedback unit configured to generate motion haptic feedback based on the acceleration information from a viewpoint of a viewer who views the input video.

4. The apparatus of claim 1, wherein the first-person viewpoint video processor calculates an optical flow of the first-person viewpoint video, and estimates the camera egomotion for the first-person viewpoint video based on the optical flow.

5. The apparatus of claim 1, wherein the third-person viewpoint video processor separates the target object from a background area.

6. The apparatus of claim 5, wherein the third-person viewpoint video processor calculates motion of the target object, and estimates a camera egomotion for the third-person viewpoint video based on the background area.

7. The apparatus of claim 6, wherein the third-person viewpoint video processor estimates the global motion of the target object in a global coordinate system by considering the camera egomotion for the third-person viewpoint video for the motion of the target object.

8. The apparatus of claim 1, wherein the input video is a two-dimensional (2D) or three-dimensional (3D) video.

9. A method of providing a motion haptic effect using video analysis, the method comprising:
estimating a camera egomotion for a first-person viewpoint video;
converting the camera egomotion for the first-person viewpoint video into acceleration information; and
generating motion haptic feedback based on the acceleration information from a viewpoint of a viewer who views the first-person viewpoint video.

10. The method of claim 9, wherein the estimating of the camera egomotion for the first-person viewpoint video comprises calculating an optical flow of the first-person viewpoint video, and estimating the camera egomotion for the first-person viewpoint video based on the optical flow.

11. The method of claim 9, wherein the first-person viewpoint video is a two-dimensional (2D) or three-dimensional (3D) video.

12. A method of providing a motion haptic effect using video analysis, the method comprising:
estimating a global motion of a target object for tracking included in a third-person viewpoint video;
converting the global motion of the target object into acceleration information; and
generating motion haptic feedback based on the acceleration information from a viewpoint of a viewer who views the third-person viewpoint video.

13. The method of claim 12, wherein the estimating of the global motion of the target object for tracking included in the third-person viewpoint video comprises:
separating the target object from a background area;
calculating motion of the target object;
estimating a camera egomotion for the third-person viewpoint video based on the background area; and
estimating the global motion of the target object in a global coordinate system by considering the camera egomotion for the third-person viewpoint video for the motion of the target object.

14. The method of claim 12, wherein the third-person viewpoint video is a two-dimensional (2D) or three-dimensional (3D) video.

15. A method of providing a motion haptic effect using video analysis, the method comprising:
analyzing a camera viewpoint of an input video and classifying the input video as a first-person viewpoint video or a third-person viewpoint video;
estimating a camera egomotion for the first-person viewpoint video when the input video is classified as the first-person viewpoint video; and
estimating a global motion of a target object for tracking included in the third-person viewpoint video when the input video is classified as the third-person viewpoint video.

16. The method of claim 15, further comprising converting the camera egomotion for the first-person viewpoint video or the global motion of the target object into acceleration information.

17. The method of claim 16, further comprising generating motion haptic feedback based on the acceleration information from a viewpoint of a viewer who views the input video.
